(19) United States
(12) Patent Application Publication
(10) Pub. No.: US 2005/0089021 A1
(43) Pub. Date: Apr. 28, 2005

(54) Integrated communication device

(76) Inventor: Jordi Vallejo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/689,651

(22) Filed: Oct. 22, 2003

(51) Int. Cl. H04L 12/66

(52) U.S. Cl. 370/352

(57) ABSTRACT

An integrated communication device includes a housing case having at least a USB port installed for plugging to a personal computer to connect to the Internet, and at least an RJ11 port for an RJ11 plug to connect to PSTN, a control circuit inside the housing case and comprising a VoIP USB controller, and a PSTN line controller for integrating signals and outputting signals an output end, and an output end for connecting to a wired or wireless phone. The communication device is thus a device that integrates both Internet phones and PSTN phones.

### BACKGROUND OF THE INVENTION

1. Field of the Invention

The present invention generally relates to a communication device and, more particularly, to an integrated communication device that provides an all-purpose voice message transmission and reception to a wide range of Internet phones, wired and wireless phones.

2. The Related Art

As the information technology progresses, more and more communication devices are developed to provide general consumers with the capability to exchange business or personal information effectively through wired or wireless transmission. Such a rapid information flow is becoming an integral part of modem industrial life.

A most commonly seen example of the communication device is telephones. In addition to the well known PSTN and mobile phones, the Internet phones that uses Internet as the transmission media is gaining popularity. This does not only provide more alternatives for communication channels, but also facilitates more types of advanced applications while lowering the communication costs.

However, as each different type of communication devices usually uses a different and separate signal transmission system, effective integration of these systems is difficult to achieve. For example, PSTN network uses different transmission system from the mobile phones, while Internet phones use Internet as the transmission media. The phones used in a household may include the aforementioned types. Because each type pf phone has own accessories, it causes inconvenience to operate and store these different types of phones and their accessories.

### SUMMARY OF THE INVENTION

Thus, the primary object of the present invention is to provide an integrated communication device that can be used with Internet phone, wired or wireless PSTN for transmission and reception of messages.

The present invention comprises a housing case, a control circuit housed inside the case, and an output end. The case further comprises at least a USB port for plugging to a personal computer to connect to the Internet phones, and at least an RJ11 port for an RJ11 plug to connect to PSTN.

The control circuit inside the case further comprises a USB signal controller and a PSTN controller. The two types of signals are integrated and sent to the output end. The output end connects to a wired or wireless phone, so that the present invention forms a communication device that integrates Internet phones and PSTN phones.

The other embodiments of the present invention can also be designed for Internet phones using different systems.

The case of the present invention can also comprise at least an RJ45 port for an RJ45 plug to connect to Internet phones, and at least an RJ11 port for an RJ11 plug to connect to PSTN. The control circuit inside the case comprises a data process memory controller, and a PSTN controller. The two types of signals are integrated and sent to the output end. The output end connects to a wired or wireless phone, so that the present invention forms a communication device that integrates Internet phones and PSTN phones.

In another embodiment of the present invention, the housing case comprises a receiver for receiving wireless broadband local area network (LAN) signal in order to connect to Internet phones, and an RJ11 port for an RJ11 plug to connect to PSTN. The control circuit inside the case further comprises a wireless router access controller, a data process memory controller, and a PSTN controller. The two types of signals are integrated and sent to the output end. The output end connects to a wired or wireless phone, so that the present invention forms a communication device that integrates Internet phones and PSTN phones.

Different types of receivers or ports for receiving wired or wireless signals can be installed on the same housing case. The control circuit inside the housing case processes the different received signals, and outputs to a single phone set. Therefore, the present invention simplifies the communication device and accessories because multiple functions are integrated into a single case. There is no need to use different phones for different occasions. It also simplifies the operation of communication device, and improves the communication efficiency.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a schematic diagram of a first embodiment of the present invention;

FIG. 2 shows a block diagram of a first embodiment of the present invention;

FIG. 3 shows a schematic diagram of a second embodiment of the present invention;

FIG. 4 shows a block diagram of a second embodiment of the present invention;

FIG. 5 shows a schematic diagram of a third embodiment of the present invention; and

FIG. 6 shows a block diagram of a third embodiment of the present invention

### DETAILED DESCRIPTION OF THE PREFERRED EMBODIMENTS

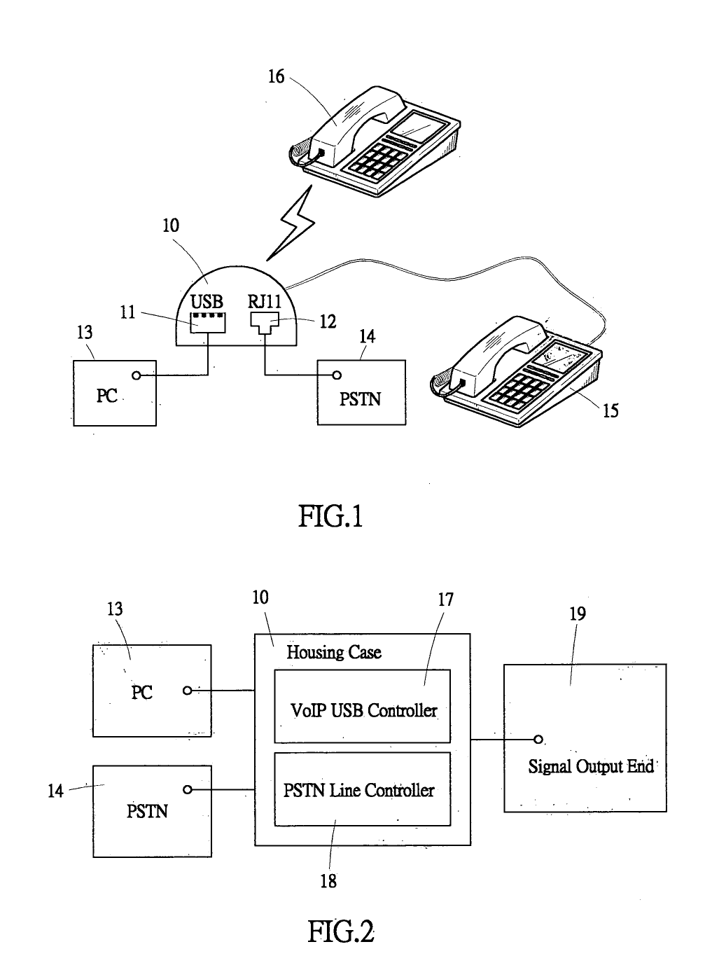

With reference to the drawings and in particular to FIGS. 1 and 2, an integrated communication device constructed in accordance with the present invention comprises a housing case 10, a control circuit housed inside housing case 10, and a signal output end 19.

The housing case 10 comprises at least a USB port 11 for plugging to a PC 13 to connect to Internet, and at least an RJ11 port 12 for an RJ11 plug to connect to PSTN 14. The control circuit inside housing case 10 comprises a VoIP USB controller 17, and a PSTN Line Controller 18. The two types of signals are integrated and sent to output end 19 for output. Output end 19 is connected to a wired phone 15 or a wireless phone 16, and thus, forming a communication device that integrates Internet phones and PSTN phones.

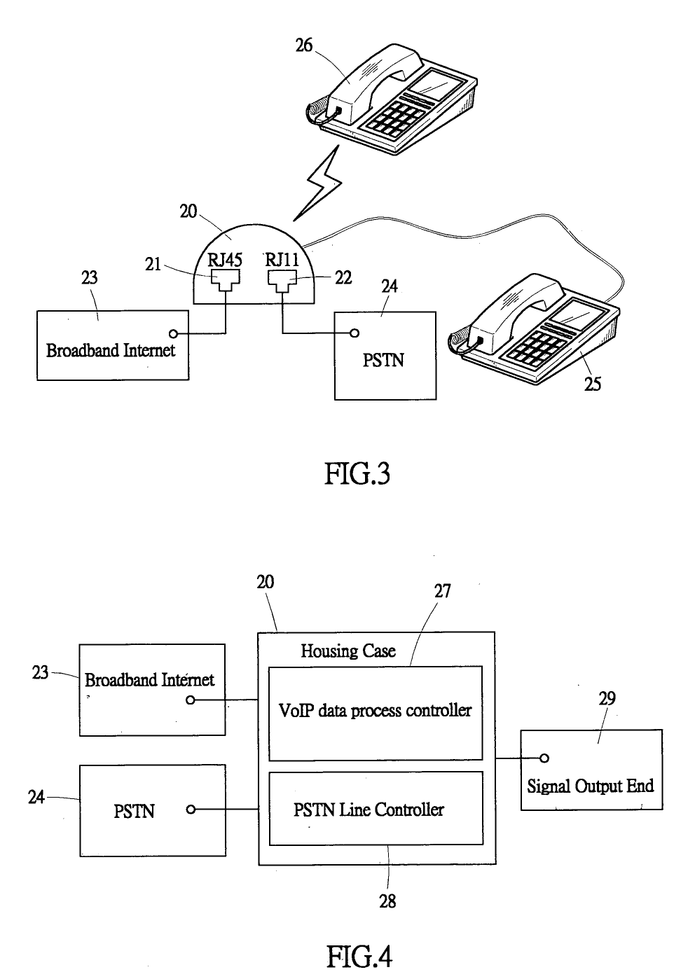

FIG. 3 shows a second embodiment of the present invention. The second embodiment of an integrated communication device of the present invention comprises a housing case 20, a control circuit housed inside housing case 20, and a signal output end 29.

As shown in FIGS. 3 and 4, the housing case 20 comprises at least an RJ45 port for an RJ45 plug to connect to broadband Internet 23, and at least an RJ11 port 22 for an RJ11 plug to connect to PSTN 24. The control circuit inside housing case 20 comprises a VoIP data process memory controller 27, and a PSTN Line Controller 28. The two types of signals are integrated and sent to output end 29 for output. Output end 29 is connected to a wired phone 25 or a wireless phone 26 and thus forming a communication device that integrates Internet phones and PSTN phones.

FIG. 5 shows a third embodiment of the present invention. The third embodiment of an integrated communication device of the present invention comprises a housing case 30, a control circuit housed inside housing case 30, and a signal output end 40.

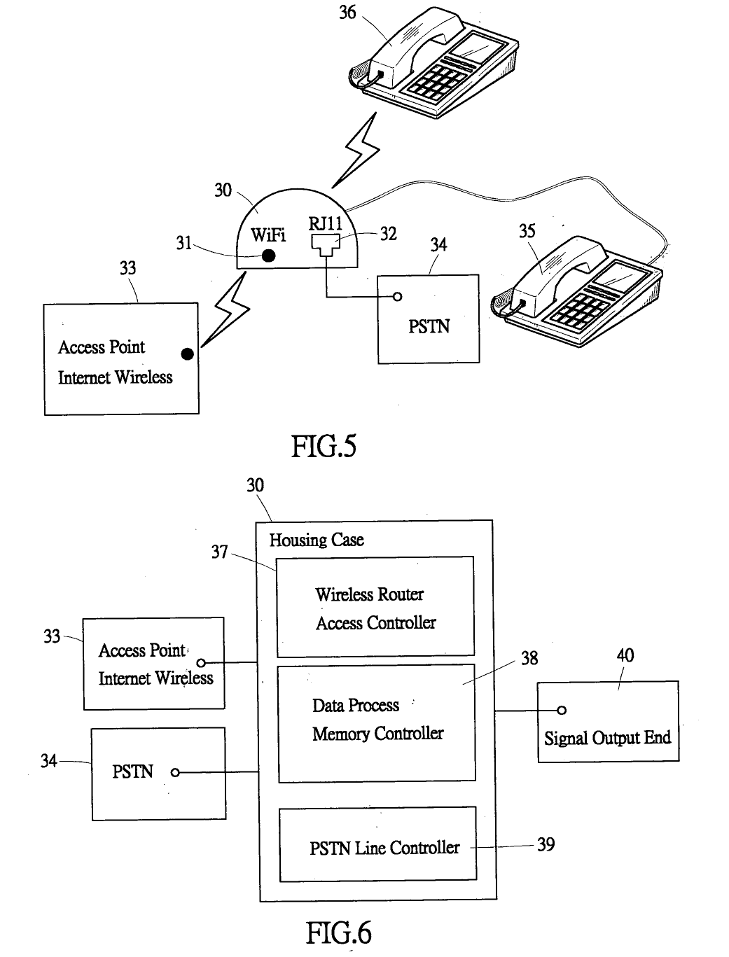

As shown in FIGS. 5 and 6, the housing case 30 comprises a WIFI receiver 31 for receiving signals from an access point Internet wireless 33 to connect to Internet, and at least an RJ11 port 32 for an RJ11 plug to connect to PSTN 34. The control circuit inside housing case 30 comprises a wireless router access controller 37, a data process memory controller 38, and a PSTN Line Controller 39. The signals are integrated and sent to output end 40 for output. Output end 40 is connected to a wired phone 35 or a wireless phone 36 and thus forming a communication device that integrates Internet phones and PSTN phones.

In summary, the present invention provides a communication device that comprises a single housing case installed with different types of receivers and ports for receiving signals from different systems. The control circuit integrated the signals, and output to a single output end, which is connected to a single phone set. This simplifies the communication device, and improves the communication efficiency.

The housing case of the present invention can be the case of a conventional telephone, or a stand-alone case as described in aforementioned embodiments.

Compared to the conventional arts, the present invention has the advantage of ease of operation because there is no need to use separate phones for different transmission systems.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

1. An integrated communication device comprising:
a housing case having at least a USB port for plugging to a PC to connect to Internet, and at least an RJ11 port for an RJ11 plug to connect to PSTN;
a control circuit inside the housing case and comprising a VoIP USB controller, and a PSTN line controller for integrating signals and outputting signals an output end; and
an output end, for connecting to a wired or wireless phone.

2. The integrated communication device as claimed in claim 1, wherein the housing case comprises an RJ45 port for an RJ45 plug to connect to the broadband Internet, and the control circuit inside the housing case comprises a VoIP data process memory controller for integrating signals, and outputting signals to the output end.

3. The integrated communication device as claimed in claim 1, wherein the housing case comprises a WIFI receiver for receiving signals from an access point Internet wireless to connect to Internet, and the control circuit inside the housing case comprises a wireless router access controller and a data process memory controller for integrating signals, and outputting signals to the output end.

4. The integrated communication device as claimed in claim 1, wherein the housing case is a case of a phone set.
